(19) United States
(12) Patent Application Publication
(10) Pub. No.: US 2025/0071487 A1
(43) Pub. Date: Feb. 27, 2025

(54) METHOD FOR OPERATING A HEARING DEVICE AND HEARING DEVICE

(71) Applicants: Sivantos Pte. Ltd., Singapore (SG); Widex A/S, Lynge (DK)

(72) Inventors: Omid GHATREH SAMANI, Erlangen (DE); Klaus KROGSGAARD, Lynge (DK); Manu TOM, Erlangen (DE)

(21) Appl. No.: 18/810,772

(22) Filed: Aug. 21, 2024

(30) Foreign Application Priority Data
Aug. 21, 2023 (DE) 10 2023 207 980.1

(51) Int. Cl. H04R 25/00

(52) U.S. Cl. CPC H04R 25/505; H04R 25/604; H04R 25/609

(57) ABSTRACT

A hearing device includes a digital signal processing unit, a first electrical component, in particular a loudspeaker, and a second electrical component, in particular a microphone. The first electrical component is driven by the signal processing unit by way of two electrical line wires or interference source lines, and the second electrical component is connected to an electrical connecting line or receiver line. Each interference source line transmits a respective digital control signal during operation. To reduce or prevent coupling of interference effects to a signal transmitted via the receiver line, the two control signals fed into the interference source lines by the signal processing unit are modulated so a difference signal pertaining to the two control signals applied to the first electrical component is formed as a bipolar control signal alternating between precisely two voltage values, and a common mode signal formed from the two control signals is constant.

The invention relates to a method for operating a hearing device and to a hearing device.

The hearing device is in particular a hearing aid intended to compensate for a hearing impairment in a person with impaired hearing.

Such hearing aids, but also hearing devices in general, comprise a digital signal processing unit, containing an amplifier part, that is used in particular to drive a receiver. The receiver is typically in the form of an electrodynamic loudspeaker. The receiver is habitually connected to the amplifier part of the signal processing unit by way of a two-wire connecting line that is used to transmit a high-frequency digital, modulated control signal during operation.

The configuration of the receiver as an electrodynamic loudspeaker results in the two control signals being applied to a coil of the receiver. In particular also for energy saving reasons, the control signals are modulated (pulse width modulation or pulse density modulation) in such a way that three different voltage values (−1, 0, +1) are applied to the receiver.

Hearing devices habitually comprise input transducers, in particular microphones, that convert an acoustic sound signal into an electrical signal that is processed further by the signal processing unit and relayed to the receiver as a conditioned output signal in the form of the two control signals.

Furthermore, it is known practice to configure a hearing device to contain a microphone that is arranged in the auricle. This is also referred to as a pinna microphone hereinbelow. It is used to produce the so-called pinna effect. When worn, the pinna microphone is arranged in the auricle and oriented to the rear. This microphone is typically an analog microphone that is connected to the signal processing unit by way of a single-wire connecting line in order to transmit an analog received signal.

In particular in RIC (Receiver In Canal) hearing devices, this single-wire connecting line is laid jointly with the two-wire control line for the receiver, for example in a shared tube.

Furthermore, there may be provision for in particular analog sensors, such as a temperature sensor or a pressure sensor.

The compact design of the hearing devices means that there is generally the problem that coupling effects can result in interference signals being transmitted between different lines. Specifically, the two-wire control line routed to the receiver acts as a source of interference. Signals transmitted to the pinna microphone via the connecting line, for example, are very sensitive to interference. To prevent interference with such signals, various measures are known, for example shielding, laying the different lines with as much physical separation as possible and/or twisting the lines.

It is an object of the invention to prevent interference for the transmission of signals.

The object is achieved according to the invention by way of a method for operating a hearing device having the features of claim 1 and by way of a hearing device having the features of claim 11.

The advantages and preferred configurations mentioned with regard to the method also apply, mutatis mutandis, to the hearing device, and vice versa.

The hearing device is in particular a hearing aid. The hearing device generally comprises a digital signal processing unit, a first electrical component, in particular a receiver and specifically an electrodynamic loudspeaker, and a second electrical component, in particular a microphone. The first electrical component is driven by the signal processing unit by way of two electrical line wires, each of which is referred to as an interference source line, of a two-wire control line, and the second electrical component is connected to an electrical connecting line referred to as a receiver line. During operation, each interference source line is used to transmit a respective digital control signal. Parasitic effects, in particular parasitic capacitances, mean that each interference source line couples an interference signal into the receiver line. To at least minimize or prevent influence on a signal transmitted via the receiver line, the signal processing unit is now configured in such a way that the control signals fed into the two interference source lines during operation are modulated in such a way that a difference signal pertaining to the two control signals that is applied to the first electrical component, that is to say specifically to the receiver, is in the form of a bipolar control signal that alternates between precisely two voltage values, and that a common mode signal formed from the two control signals is furthermore constant. The common mode signal in this case is formed by the averaged voltage of the voltage values of the two control signals. The applied control signal forms in particular the supply voltage for the first electrical component, in particular for the receiver.

As mentioned at the outset, for energy consumption reasons the control signals are modulated in such a way that the control signal (difference signal) pertaining to the two control signals that is applied to the receiver changes between the three voltage levels −1, 0, +1. However, in the case of long control lines laid close together and specifically in the case of pinna microphones, such modulation has the disadvantage that the effect of crosstalk is a particular problem.

To avoid such problems, there is provision in the present case for the difference signal to change between only two voltage values, in particular between +1 and −1. This configuration is based on the consideration that the typically capacitive coupling effects mean that these two control signals are coupled into the receiver line and summed there. Furthermore, this configuration is based on the consideration that the specific modulation of the control signals means that the common mode signal is constant and therefore no crosstalk is produced. Crosstalk is produced only when the common mode signal varies, as is the case with conventional modulation of the control signals and driving of the receiver.

The present configuration thus involves a symmetrical, bipolar control signal consciously being applied to the receiver, with the result that a common mode signal is constant, in order to at least reduce interference effects due to crosstalk. The present invention consciously accepts a higher energy consumption in this case.

The receiver line is typically connected to the signal processing unit to allow the signal transmitted via the receiver line to be handled further. The signal processing unit evaluates this signal transmitted via the receiver line. Furthermore, as described at the outset, the signal processing unit is also used to generate the conditioned output signal, which is preferably fed into the interference source line in the form of the two control signals.

Where reference is made in the present case to a bipolar control signal applied to the electrical component (i.e. the bipolar difference signal pertaining to the two control signals that is applied to the first electrical component), this is understood to mean that this bipolar control signal changes to and fro between precisely two voltage values, specifically in particular between a positive and a negative voltage value (+1 and −1). This voltage value is in particular the positive and the negative voltage value of a power supply, for example a battery. The voltage value is typically in the region of a few volts (e.g. 1 V to 5 V).

To generate the bipolar control signal that is applied to the electrical component, the two control signals are preferably in antiphase, specifically in such a way that one control signal has the voltage value+1 and the other control signal has the voltage value 0. This ensures that the bipolar difference signal/control signal applied to the first component (receiver) adopts only the values +1 and −1. The receiver line is in particular a so-called single-end line, that is to say where the second component is connected only by way of a single signal wire for signal transmission. The receiver line—unlike the control line—is therefore distinctly not a two-wire signal line.

In a preferred configuration, the second component is preferably an analog component that feeds an analog signal into the receiver line.

The second component is preferably a microphone, specifically in particular a so-called pinna microphone.

The hearing device is therefore preferably also an RIC (Receiver In Canal) hearing device. The receiver line is routed toward the receiver jointly with the two-wire control line, preferably inside a shared tube. The two-wire control line and the (single-wire) receiver line are therefore routed close together over a comparatively long distance.

Alternatively or additionally, the second component is an in particular analog sensor, for example a temperature sensor or a pressure sensor.

The second component is preferably connected to an analog-digital converter, which converts the analog signal into a digital signal, by way of the receiver line. Said digital signal is then normally handled further by the digital signal processing unit.

The control signals are preferably generated by an amplifier part of the signal processing unit. This amplifier part is in particular an H bridge and/or a so-called class D amplifier.

An exemplary embodiment of the invention is explained in more detail hereinbelow with reference to the figures, in which

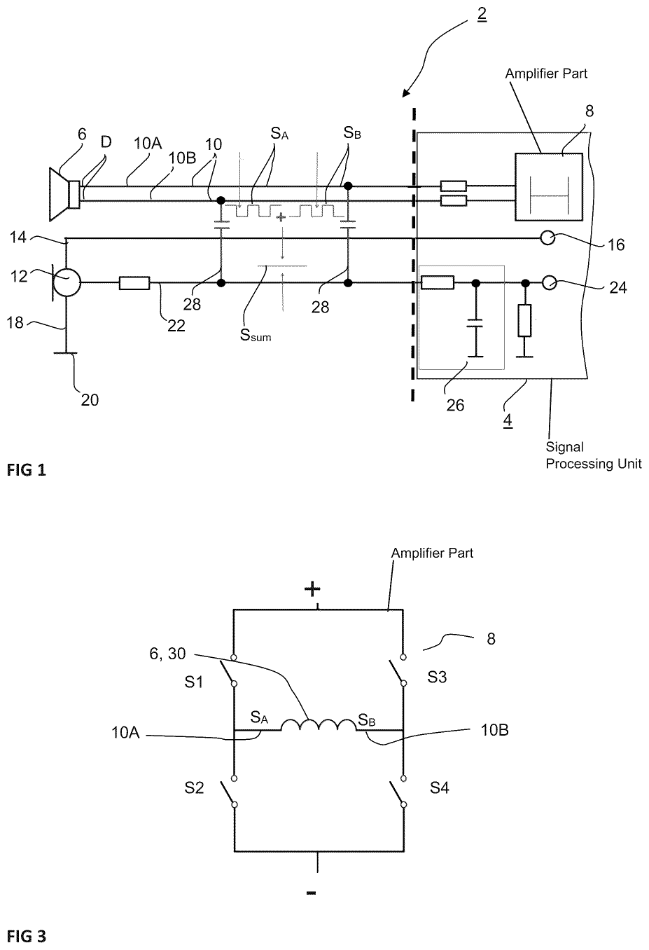

FIG. 1 shows a highly simplified circuit diagram of a hearing device in a simplified block diagram presentation,

FIG. 2 shows a combined presentation of multiple signal characteristics, and

FIG. 3 shows an H bridge with a connected receiver.

The hearing device 2 presented in a simplified form in FIG. 1 is in particular a hearing aid designed to compensate for a user-specific hearing impairment. To this end, the hearing aid is designed and adjusted in a manner known per se so that in particular amplification, for example frequency-dependent amplification, matched to the user-specific hearing impairment is performed. The hearing device 2 generally comprises a receiver/signal transducer (not depicted in the figure), for example a microphone, that normally converts an acoustic signal into a digital input signal and forwards the latter to a digital signal processing unit 4, in which the digital input signal is conditioned, in particular amplified, in accordance with the user-specific settings and forwarded as a conditioned output signal to a receiver, which is in particular in the form of a loudspeaker 6.

To this end, the digital signal processing unit 4 encompasses in particular an amplifier part 8, which preferably comprises an H bridge and/or is in the form of a so-called class D amplifier. Said amplifier part is connected to the loudspeaker 6 by way of a two-wire control line 10 and therefore by way of two line wires. The line wires are referred to as interference source lines 10A, 10B hereinbelow.

This two-wire control line 10 is used to relay the output signal conditioned by the control unit 4. To this end, each of the two interference source lines 10A, 10B is used to transmit a modulated (pulse width modulated or pulse density modulated) control signal S_{A}, S_{B}. Each of these control signals S_{A}, S_{B} is therefore made up of a (modulated) pulse train of individual positive voltage pulses having the amplitude+1 (+1 means that the voltage value of a supply voltage, e.g. the battery voltage, is applied).

Furthermore, the hearing device 2 comprises a pinna microphone 12 that, for a supply of power, is connected firstly to a supply voltage 16 by way of a supply line 14 and secondly to a ground potential 20 by way of a ground line 18.

Furthermore, the pinna microphone 12 is connected to the signal processing unit 4, specifically in particular to an analog-digital converter 24, by way of a receiver line 22. In the exemplary embodiment, the analog-digital converter 24 has a filter 26, in particular a low pass filter, disposed upstream of it.

The hearing device 2 is preferably an RIC hearing device. The hearing device comprises a main part, not depicted in more detail here, with a separate housing, the main part typically being worn behind the ear. The self-contained housing of the main part holds a multiplicity of the components of the hearing device 2 and in particular the signal processing unit 4.

The two-wire control line 10 and the receiver line 22 and typically also the supply line 14 are routed jointly close together, and in particular inside a shared tube, from the main part to an earpiece, which is remote therefrom, of the hearing device 2, which is inserted into the ear, specifically into the auricle, or into the ear canal, of the user. Additionally, the ground line 18 is frequently also laid, in addition, together with the aforementioned lines and in particular jointly in the shared tube (not depicted). This earpiece comprises the loudspeaker 6. The line depicted in dashes in FIG. 1 forms the interface between the main part and the components arranged outside the main part.

During operation, the pinna microphone 12 is used to capture acoustic signals and to forward them to the signal processing unit 4 via the receiver line 22 as an analog (data) signal.

In particular due to its immediate proximity to the control line 10, this analog signal is very sensitive to interference signals that are coupled into the receiver line 22 as a result of parasitic effects due to the control signals S_{A}, S_{B} on the two interference source lines 10A, 10B.

To illustrate these parasitic effects, FIG. 1 shows parasitic, capacitive coupling paths 28. These are not physical, wired line connections but just parasitic effects. For each control signal S_{A}, S_{B}, these parasitic effects couple an interference signal corresponding to the respective control signal S_{A}, S_{B} into the receiver line 22.

To reduce or prevent an interfering influence of these parasitic effects on the signal in the receiver line 22, there is now provision for the control signals S_{A}, S_{B} coupled into the two control lines 10A, 10B by the signal processing unit 4 and in particular by the amplifier part 8 to be modulated in such a way that the total signal (drive signal, or voltage) applied to the loudspeaker 6, which is a difference signal D (in this regard cf. also FIG. 2) between the two control signals S_{A}, S_{B}, is in the form of a bipolar signal that has just the two voltage states +1 and −1.

As is evident from the pulse trains—indicated in FIG. 1—of the control signals S_{A}, S_{B}, these control signals S_{A}, S_{B} are in antiphase form. In the present case, this is understood to mean that one control signal S_{A} has the voltage value+1 when the other control signal S_{B} has the voltage value 0, and vice versa.

At the same time, this also achieves the effect that a common mode signal C (cf. FIG. 2) has a constant value of (S_{A}+S_{B})/2=0.5. This is depicted in FIG. 1 by the sum signal Sₛᵤₘ.

The constant common mode signal C ensures that no interfering influences are coupled into the receiver line 22 because, in the present configuration, interfering influences for the (analog) data on the receiver line are produced only when the common mode signal varies.

FIG. 2 is used to explain various signal characteristics:

The first row first depicts an analog signal A by way of illustration as an oscillating wave. This analog signal A is represented by a digital signal. Specifically, the oscillating wave is reproduced by suitable pulse trains that form the control signals S_{A}, S_{B} (rows 2 and 3).

These control signals S_{A}, S_{B} are applied to the loudspeaker 6 and therefore define the drive signal therefor, or the voltage applied thereto. Said voltage is formed by the difference voltage D=S_{A}−S_{B} (4^{th} row). This alternately takes the voltage values+1 and −1.

Furthermore, the fifth row of FIG. 2 depicts the common mode signal C, which has a constant signal level having the voltage value 0.5.

FIG. 3 is used to explain how the pulse trains of the control signals S_{A}, S_{B} are produced using an H bridge as the amplifier part 8: said H bridge has a total of 4 switches S1-S4, which, as depicted, are connected to a supply voltage and to a ground potential (GND). The supply voltage is in particular the voltage of a supply battery of the hearing device 2. The supply voltage is represented by the plus symbol (+) and the ground potential is represented by the minus symbol (−). One interference source line 10A is connected between the switch pairs S1 and S2 and the other interference source line 10B is connected between the switch pairs S3 and S4. The ends of said interference source lines are in turn connected to the loudspeaker 6, specifically to the coil 30 thereof. The supply voltage is applied between the switches S1 and S3, and each of the switches S2 and S4 is connected to the ground potential.

For the voltage state: control signal S_{A}=+1 and control signal S_{B}=0, the switches S1 and S4 are closed, while S2 and S3 are open (first switch position configuration). The difference signal D applied to the loudspeaker 6, in particular to the coil 30, or the voltage applied to the coil, results as follows:

$$D = {S}_{A} - {S}_{B} = 1 - 0 = + 1$$

For the voltage state: control signal S_{A}=0 and Control signal S_{B}=+1, the switches S2 and S3 are closed, while S1 and S4 are open (second switch position configuration). The difference signal D applied to the loudspeaker 6, in particular to the coil 30, or the voltage applied to the coil, results as follows:

$$D = {S}_{A} - {S}_{B} = 0 - 1 = - 1$$

Suitable actuation of the switches S1-S4 results in the pulse trains depicted in FIG. 2 being obtained. The H bridge is merely changed over between the two switch position configurations explained above.

The principle described here with the specifically configured control signals S_{A}, S_{B} is not restricted to the example application described here with the pinna microphone 12 and the RIC hearing device. As an alternative to the pinna microphone 12, the second component is for example an in particular analog sensor, for example a temperature sensor or a pressure sensor. Instead of an RIC hearing device, other hearing device types, for example a BTE (Behind The Ear) hearing device, may generally also be involved.

### LIST OF REFERENCE SIGNS

2 hearing device
4 signal processing unit
6 loudspeaker
8 amplifier part
10 control line
10′A, 10B interference source line
12 pinna microphone
14 supply line
16 supply voltage
18 ground line
20 ground potential
22 receiver line
24 analog-digital converter
26 filter
28 coupling line
30 coil
S_{A}, S_{B} control signal
Sₛᵤₘ sum signal
A analog signal
D difference signal
C common mode signal

1-12. (canceled)

13. A method for operating a hearing device, the method comprising:
providing a digital signal processing unit, a first electrical component or loudspeaker, and a second electrical component or microphone;
using the signal processing unit to drive the first electrical component by way of two electrical line wires, each of the electrical line wires being an interference source line;
connecting the second electrical component to an electrical connecting line being a receiver line;
using each interference source line to transmit a respective one of two digital control signals during operation; and
modulating the two digital control signals fed into the interference source lines by the signal processing unit, causing a difference signal pertaining to the two digital control signals applied to the first electrical component to be formed as a bipolar control signal alternating between precisely two voltage values, and causing a common mode signal formed from the two digital control signals to be constant.

14. The method according to claim 13, which further comprises changing the bipolar control signal between voltage values of +1 and −1.

15. The method according to claim 13, which further comprises providing the digital control signals as antiphase signals with one control signal having a voltage value of +1 and another control signal having a voltage value of 0.

16. The method according to claim 13, which further comprises providing the receiver line as a single-end line.

17. The method according to claim 13, which further comprises providing the second component as an analog component feeding an analog signal into the receiver line.

18. The method according to claim 13, which further comprises providing the second component as a microphone or a pinna microphone.

19. The method according to claim 13, which further comprises providing the second component as an analog sensor.

20. The method according to claim 13, which further comprises connecting the second component to an analog-digital converter of the signal processing unit by way of the receiver line.

21. The method according to claim 13, which further comprises using an amplifier part or an H bridge of the signal processing unit to generate the control signals.

22. The method according to claim 13, which further comprises routing the two line wires jointly with the receiver line, and providing the hearing device as an RIC hearing device.

23. A hearing device or hearing aid, comprising:
a digital signal processing unit;
a first electrical component or loudspeaker;
a second electrical component or microphone;
two electrical line wires each being an interference source line connecting said first electrical component to said signal processing unit;
said signal processing unit being configured to use each interference source line to transmit a respective digital control signal to said first electrical component during operation; and
an electrical connecting line being a receiver line connected to said second electrical component;
said signal processing unit being configured to modulate the two digital control signals fed into said interference source lines during operation, causing a difference signal pertaining to the two digital control signals applied to said first electrical component to be formed as a bipolar control signal alternating between precisely two voltage values, and causing a common mode signal formed from the two digital control signals to be constant.

24. The hearing device according to claim 23, wherein:
said signal processing unit includes an amplifier part or H bridge configured to generate the two digital control signals;
said signal processing unit is configured to provide the two digital control signals in antiphase, and to provide one digital control signal with a voltage value of +1 and another digital control signal with a voltage value of 0;
said signal processing unit is configured to cause the bipolar control signal to change between voltage values of +1 and −1;
said receiver line is a single-end line; and
said second component is an analog microphone or pinna microphone.
